(19) United States
(12) Patent Application Publication
(10) Pub. No.: US 2026/0184598 A1
(43) Pub. Date: Jul. 2, 2026

(54) Positive Electrode Material Powder, and Positive Electrode and Lithium Secondary Battery Including the Same

(71) Applicant: LG Energy Solution, Ltd., Seoul (KR)

(72) Inventors: Hyeong Il Kim, Daejeon (KR); Eun Sol Lho, Daejeon (KR); Jin Tae Hwang, Daejeon (KR); Su Yeon Oh, Daejeon (KR); Seok Jin Lee, Daejeon (KR); Eun Byeol Cho, Daejeon (KR)

(73) Assignee: LG Energy Solution, Ltd., Seoul (KR)

(21) Appl. No.: 19/431,061

(22) Filed: Dec. 23, 2025

(30) Foreign Application Priority Data
Dec. 27, 2024 (KR) 10-2024-0199364

(51) Int. Cl. C01G 53/506; H01M 10/052

(52) U.S. Cl. CPC C01G 53/506; H01M 10/052; C01P 2004/03; C01P 2004/45; C01P 2004/51; C01P 2004/61; C01P 2006/10; C01P 2006/11; C01P 2006/40

(57) ABSTRACT

The present disclosure relates to a positive electrode material powder, and a positive electrode and a lithium secondary battery including the same. The positive electrode material powder includes a lithium nickel-based oxide having a nickel content of 80 mol % or more among metals excluding lithium is 80 mol % or more, has a D₅₀ of 4 μm or more, and has a degree of single-particle formation represented by Equation

$$Degree of single - particle formation ( \% ) = \frac{\sqrt[2]{A / π}}{{D}_{s o}} \times 100$$

in a range of about 35% to 60%. In Equation, A (unit: μm²) is a median of primary particle areas of the positive electrode material powder measured through SEM image analysis, and the D₅₀ (unit: μm) is a volumetric cumulative average of the positive electrode material powder measured using a particle size analyzer.

### CROSS-REFERENCE TO RELATED APPLICATIONS

This application is based on and claims priority from Korean Patent Application No. 10-2024-0199364 filed on Dec. 27, 2024, with the Korean Intellectual Property Office, the disclosure of which is incorporated herein in its entirety by reference.

### TECHNICAL FIELD

The present disclosure relates to a positive electrode active material powder for a lithium secondary battery, and a positive electrode and a lithium secondary battery including the same.

### BACKGROUND

As industries related to products such as mobile phones, laptop computers, and electric vehicles that use lithium secondary batteries have been rapidly growing, research and development efforts to improve the performance of lithium secondary batteries have been actively conducted. A lithium secondary battery produces electrical energy through oxidation and reduction reactions that occur when lithium ions are inserted into and extracted from a positive electrode and a negative electrode. For example, the battery is charged as lithium ions of the positive electrode move to the negative electrode, and the battery is discharged by releasing energy as lithium ions of the negative electrode return to the positive electrode.

A secondary battery generally includes four core components: a positive electrode, a negative electrode, a separator, and an electrolyte, and these components organically interact with one another to store and release energy while repeatedly undergoing charging and discharging. In addition, the positive electrode and the negative electrode of a secondary battery serve as core electrodes in which oxidation and reduction reactions occur, respectively, in which the positive electrode performs an oxidation reaction (ion release) and the negative electrode performs a reduction reaction (ion storage). In general, the positive electrode and the negative electrode determine the performance of the secondary battery, and the electrolyte and the separator determine the safety of the secondary battery. Meanwhile, the positive electrode and the negative electrode of the secondary battery respectively include a positive electrode active material and a negative electrode active material. The positive electrode active material determines the capacity and voltage of the secondary battery, and the negative electrode active material stores and releases lithium ions to generate electrical energy.

### SUMMARY

The present disclosure provides a positive electrode material powder for a lithium secondary battery, in which the particle diameter of the powder and the size of primary particles are controlled, such that the powder has a high nickel content while exhibiting relatively low gas generation during electrode fabrication, easy slurry processability, and excellent high-temperature stability.

In addition, the present disclosure provides a positive electrode and a lithium secondary battery having excellent capacity characteristics, lifetime characteristics, and high-temperature stability by including the above-mentioned positive electrode material powder.
[1] The present disclosure provides a positive electrode material powder including a lithium nickel-based oxide having a nickel content of about 80 mol % or more among metals excluding lithium, in which the positive electrode material powder has an average particle size (D₅₀) of 4 μm or more, and has a degree of single-particle formation, represented by Equation 1 below, of about 35% to 60%.

$$Degree of single - particle formation ( \% ) = \frac{\sqrt[2]{A / π}}{{D}_{s o}} \times 100 \qquad [ Equation 1 ]$$

in Equation 1, A (unit: μm²) is a median of primary particle areas of the positive electrode material powder measured through SEM image analysis, and D₅₀ (unit: μm) is a volumetric cumulative average of the positive electrode material powder measured using a particle size analyzer.
[2] The present disclosure provides the positive electrode material powder according to [1], in which the positive electrode material powder includes a single particle formed from one primary particle or a quasi-single-particle that is an aggregate of 50 or fewer primary particles.
[3] The present disclosure provides the positive electrode material powder according to [1] or [2], in which the lithium nickel-based oxide has a composition represented by Formula 1:

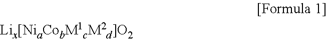

in Formula 1, M¹ is Mn, Al, or a combination thereof, M² includes one or more elements selected from Zr, W, Ti, Mg, Ba, Ca, Ta, Nb, and Mo, and x, a, b, c, and d satisfy 0.8≤x≤1.2, 0.7≤a<1.0, 0<b<0.3, 0<c<0.3, and 0≤d<0.1.
[4] The present disclosure provides the positive electrode material powder according to at least one of [1] to [3], in which

$$\sqrt[2]{A / π}$$

in Equation 1 is about 1 μm to 4 μm.
[5] The present disclosure provides the positive electrode material powder according to at least one of [1] to [4], in which the positive electrode material powder has a tap density of about 1.80 g/cc or more.
[6] The present disclosure provides the positive electrode material powder according to at least one of [1] to [5], in which the positive electrode material powder has a rolling density of about 3.50 g/cc or more, as measured after being pressed at 9 tons.
[7] The present disclosure provides the positive electrode material powder according to at least one of [1] to [6], further including a coating layer including one or more coating elements selected from Al, Ti, W, B, F, P, Mg, Ni, Co, Fe, Cr, V, Cu, Ca, Zn, Zr, Nb, Mo, Sr, Sb, Bi, Si, and S on a surface of the lithium nickel-based oxide.
[8] The present disclosure provides the positive electrode material powder according to at least one of [1] to [7], in which the positive electrode material powder has an average particle size (D₅₀) of about 4 μm to 7 μm.
[9] The present disclosure provides a positive electrode for a lithium secondary battery, including the positive electrode material powder according to at least one of [1] to [8].

[10] The present disclosure provides a lithium secondary battery including the positive electrode of [9].

The positive electrode material powder according to the present disclosure is a positive electrode material powder including a high-nickel (high-Ni) lithium nickel-based oxide, satisfies a degree of single-particle formation, represented by Equation 1, in a range of about 35% to 60%, and maintains an average particle size (D₅₀) of about 4 μm or more, and therefore, exhibits excellent tap density and rolling density, low gas generation, and excellent high-temperature stability.

In addition, a positive electrode and a lithium secondary battery according to the present disclosure may implement excellent high-temperature stability, lifetime characteristics, and capacity characteristics by including the high-nickel positive electrode material powder having excellent rolling density and low gas generation.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 illustrates a method for manufacturing a positive electrode material powder according to an embodiment of the present disclosure.

FIG. 2 is a view illustrating a structure of a positive electrode manufactured using a positive electrode material powder according to an embodiment of the present disclosure.

FIG. 3 is a view illustrating a structure of a secondary battery manufactured by applying a positive electrode manufactured using a positive electrode material powder according to an embodiment of the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

The terms or words used in the specification and claims should not be construed as limited to their ordinary or dictionary meanings, but should be construed as having meanings and concepts consistent with the technical concept of the present disclosure based on the principle that an inventor may appropriately define the concepts of terms in order to explain his or her own invention in the best way.

The terms used herein are used only for the purpose of describing exemplary embodiments and are not intended to limit the scope of the present disclosure. Singular terms include plural terms unless the context clearly indicates otherwise.

As used herein, terms such as “include,” “comprise,” or “have,” are intended to specify the presence of stated features, numbers, steps, components, or combinations thereof, but are to be understood as not precluding the possibility of the presence or addition of one or more other features, numbers, steps, components, or combinations thereof. Herein, when a portion such as a layer, film, region, or plate is described as being formed on another portion, the direction of formation is not limited to an upper direction but includes formation in a lateral or lower direction.

In the present disclosure, the term “primary particle” refers to a particle unit in which no grain boundary is visually observed when observed at a magnification of 5,000× to 20,000× using a scanning electron microscope.

In the present disclosure, the term “single-particle type” refers to a particle including 50 or fewer primary particles and includes a “single particle” formed from one primary particle and a “quasi-single-particle” formed by agglomeration of 2 to 50 primary particles.

In the present disclosure, the term “secondary particle” refers to a particle formed by agglomeration of several tens to several hundreds of primary particles. For example, a secondary particle refers to an aggregate of 51 or more primary particles.

In the present disclosure, the term “particle” may include any one or all of a single particle, a quasi-single-particle, a primary particle, and a secondary particle.

In the present disclosure, “Doo” refers to a particle size at 50% of the volumetric cumulative particle size distribution of the positive electrode active material. D₅₀ may be measured by using a laser diffraction method. For example, D₅₀ may be measured by dispersing a positive electrode active material powder in a dispersion medium, introducing the dispersed sample into a commercially available laser diffraction particle size analyzer (e.g., Microtrac MT 3000), irradiating the dispersed sample with ultrasonic waves at about 28 kHz with an output of 60 W, and determining a particle size corresponding to 50% of the volumetric cumulative distribution.

In the present disclosure, the term “specific surface area” refers to a value measured by the BET method and may be calculated, for example, from an amount of nitrogen gas adsorbed at a liquid nitrogen temperature (77 K) using a BELSORP-mini II manufactured by BEL Japan.

As used herein, the terms “about,” “approximately,” and “substantially” are used to mean a range of the numerical value or degree, or a value close thereto, in consideration of inherent manufacturing and material tolerances (e.g., ±5%).

As positive electrode active materials for lithium secondary batteries, for example, lithium cobalt oxide, lithium nickel oxide, lithium manganese oxide, and lithium iron phosphate compounds have mainly been used. In addition, as a method for improving the low high-temperature stability while maintaining excellent reversible capacity of lithium nickel oxide, lithium composite metal oxides in which a portion of nickel is substituted with cobalt and manganese (hereinafter, simply referred to as “NCM oxides”) have been developed.

Recently, as the demand for high-power and high-capacity batteries, such as batteries for electric vehicles, has increased, attempts to increase the nickel content in NCM oxides have been actively conducted. However, high-Ni NCM oxides have limitations in application because they exhibit high lattice structural instability due to cation mixing and oxygen loss and contain a large amount of lithium impurities remaining on the surface, and thus generate a large amount of gas during high-temperature storage or charge-discharge processes when used as a positive electrode material.

Accordingly, a technique for manufacturing a single-particle-type positive electrode active material by increasing a calcination temperature has been proposed. In the case of such single-particle-type positive electrode active materials, because the contact area with an electrolyte is smaller compared with conventional secondary-particle-type positive electrode active materials, side reactions with an electrolyte are reduced, particle strength is excellent such that particle breakage during electrode fabrication is reduced, and when applied to a battery, gas generation is reduced and lifetime characteristics are excellent. However, in single-particle-type positive electrode active materials, as a primary particle size increases within an aggregate particle, high-temperature stability decreases, and therefore, appropriate control is still required.

In consideration of these points, the present disclosure provides a positive electrode material powder including a high-Ni lithium-nickel-based oxide and exhibiting excellent tap density and rolling density, low gas generation, and excellent high-temperature stability.

Hereinafter, the present disclosure will be described in more detail.

Because single-particle-type particles have a smaller contact area with an electrolyte compared with secondary-particle-type particles, side reactions with an electrolyte are reduced, and because particle strength is excellent such that particle breakage during an electrode fabrication process is reduced, the single-particle-type particles may contribute to reducing gas generation of a lithium secondary battery. However, in order to overcome the limitation that high-nickel positive electrode materials generate a large amount of gas, when increasing the size of primary particles and the proportion of single-particle-type particles, there exists a disadvantage in that, as the size of primary particles within agglomerated particles increases, high-temperature stability becomes inferior. Therefore, in order to obtain a positive electrode material having excellent high-temperature stability, capacity characteristics, and lifetime characteristics in a well-balanced manner, it is important to control the proportion of single-particle-type particles.

By utilizing the fact that, when an average particle size D₅₀ of a positive electrode material powder and a primary particle size satisfy a specific relationship, gas generation may be minimized and excellent high-temperature characteristics may be achieved while increasing the rolling density, the present disclosure provides a positive electrode material for a lithium secondary battery that includes a high-nickel positive electrode material and has excellent capacity and exhibits excellent high-temperature stability, excellent rolling density, and low gas generation.

Hereinafter, each configuration constituting the present disclosure will be described in more detail.

### Positive Electrode Material Powder

The positive electrode material powder according to the present disclosure includes a lithium-nickel-based oxide having a nickel content of about 80 mol % or more among metals excluding lithium, has a D₅₀ of about 4 μm or more, and has a degree of single-particle formation, represented by Equation 1 below, of about 35% to 60%. Equation 1 below is an index capable of selecting a positive electrode material powder that exhibits excellent tap density and rolling density as well as excellent slurry processability, so that all of capacity characteristics, lifetime characteristics, and high-temperature stability may be secured at or above certain levels.

$$Degree of single - particle formation ( \% ) = \frac{\sqrt[2]{A / π}}{{D}_{s o}} \times 100 \qquad [ Equation 1 ]$$

In Equation 1, A (unit: μm²) refers to a median of primary particle areas of the positive electrode material powder measured by SEM image analysis, and refers, for example, to a value located in the middle when primary particle areas measured by SEM image analysis are arranged in ascending order.

In addition, the average particle size (D₅₀) (unit: μm) refers to a volumetric cumulative average of the positive electrode material powder measured using a particle size analyzer, for example, to a particle size at a point corresponding to about 50% of volumetric cumulative amount on a volumetric cumulative particle size graph obtained by a laser diffraction particle size analyzer.

According to an embodiment, the D₅₀ of the positive electrode material powder may be about 4.5 μm or more, for example, about 5.0 μm or more, or about 5.5 μm or more. In addition, the D₅₀ of the positive electrode material powder may be about 7.0 μm or less, for example, about 6.9 μm or less, or about 6.8 μm or less.

The positive electrode material powder may include single-particle-type particles composed of one primary particle, or quasi-single-particle-type particles which are aggregates of not more than about 50 primary particles, for example, about 2 to 40 primary particles or about 2 to 30 primary particles.

Equation 1 is obtained by dividing a value

$$\sqrt[2]{A / π}$$

corresponding to a diameter of a circle having the same area as A, which is a median of the primary particle areas of the positive electrode material powders measured through SEM image analysis, by D₅₀ as an average particle size of the positive electrode material powder. As the degree of single-particle formation included in Equation 1 approaches 100%, it indicates that the positive electrode material powder includes more single-particle-type particles, and as it approaches 0%, it indicates that the positive electrode material powder includes more secondary particles. According to an embodiment, when D₅₀ is about 4 μm or greater and the degree of single-particle formation according to Equation 1 satisfies about 35% to 60%, due to a relatively large particle size, excellent particle strength may be achieved, so that both lifetime characteristics and high-temperature stability may be secured at a certain level or higher while exhibiting low gas generation and excellent slurry processability.

According to an embodiment, the degree of single-particle formation according to Equation 1 may be about 35% or greater, for example, about 36% or greater, or about 37% or greater, and may be about 59% or less, for example, about 58% or less, 57% or less, or 56% or less, or about 55% or less, 54% or less, or 53% or less, or about 50% or less.

Meanwhile, the lithium nickel-based oxide may have a composition represented by Formula 1:

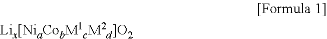

In Formula 1, M¹ is Mn, Al, or a combination thereof, and M² includes one or more elements selected from Zr, W, Ti, Mg, Ba, Ca, Ta, Nb, and Mo, and x, a, b, c, and d satisfy 0.8≤x≤1.2, 0.7≤a<1.0, 0<b<0.3, 0<c<0.3, and 0≤d<0.1.

The symbol “x” represents a molar ratio of lithium in the lithium nickel-based oxide, and may satisfy, for example, 0.9≤x≤1.2, 0.8≤x≤1.1, or 0.9≤x≤1.1. When the molar ratio of lithium satisfies the above range, a crystal structure may be stably formed.

The symbol “a” represents a molar ratio of nickel among all metals excluding lithium in the lithium nickel-based oxide, and may satisfy, for example, 0.80≤a<1.00, 0.81≤a<1.00, or 0.82≤a<1.00. When the molar ratio of nickel satisfies the above range, a high energy density may be exhibited, enabling high-capacity implementation.

The symbol “b” represents a molar ratio of cobalt among all metals excluding lithium in the lithium nickel-based oxide, and may satisfy, for example, 0<b≤0.20, 0<b≤0.18, or 0<b≤0.16. When the molar ratio of cobalt satisfies the above range, favorable resistance and output characteristics may be implemented.

The symbol “c” represents a molar ratio of the M¹ element among all metals excluding lithium in the lithium nickel-based oxide, and may satisfy, for example, 0<c≤0.20, 0<c≤0.18, or 0<c≤0.16. Meanwhile, M¹ may be Mn, or a combination of Mn and Al, and for example, may preferably be Mn.

The symbol “d” represents a molar ratio of the M² element among all metals excluding lithium in the lithium nickel-based oxide, and may satisfy, for example, 0≤d≤0.08, 0≤d≤0.05, or 0≤d≤0.03.

Meanwhile,

$$\sqrt[2]{A / π}$$

in Equation 1 may range from about 1 μm to 4 μm, for example, from about 1.1 μm to 4 μm, from 1 μm to 3.9 μm, from 1.1 μm to 3.9 μm, from 1.2 μm to 3.9 μm, from 1.2 μm to 3.8 μm, from 1.3 μm to 3.7 μm, or from 1.5 μm to 3.5 μm. When

$$\sqrt[2]{A / π}$$

satisfies the above range, particle breakage during electrode fabrication may be minimized, and side reactions on an electrode surface may be reduced.

Meanwhile, the tap density of the positive electrode material powder may be about 1.80 g/cc or more, for example, about 1.81 g/cc or more, 1.82 g/cc or more, 1.83 g/cc or 1.84 g/cc or more, or about 1.85 g/cc or more. When the tap density satisfies the above range, energy density may be improved.

Meanwhile, the positive electrode material powder may have a rolling density of about 3.50 g/cc or more after being pressurized at 9 tons, for example, about 3.51 g/cc or more, 3.52 g/cc or more, 3.53 g/cc or 3.54 g/cc or more, or about 3.55 g/cc or more. When the rolling density satisfies the above range, particle packing may become dense, thereby improving energy density.

### Method for Manufacturing Positive Electrode Material Powder

Hereinafter, a method for manufacturing a positive electrode material powder according to the present disclosure will be described.

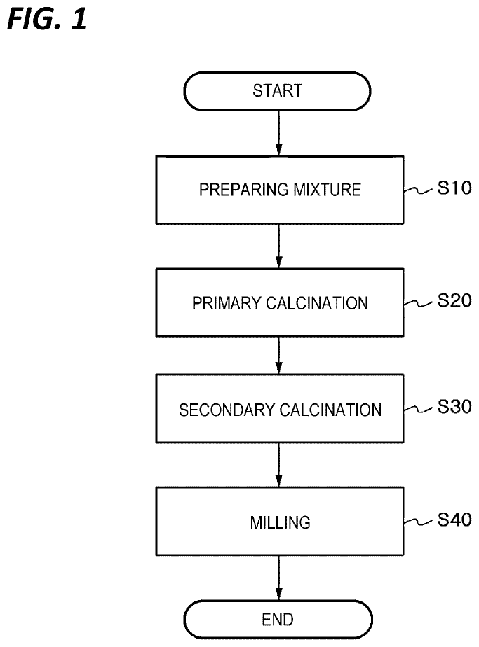

Referring to FIG. 1, a method for manufacturing a positive electrode material powder according to an embodiment of the present disclosure includes steps of: preparing a mixture by mixing a precursor having a nickel content of 80 mol % or more with a lithium raw material step (S10); performing primary calcination by calcining the mixture at 750° C. to 950° C. for 9 hours to 14 hours (S20); and performing secondary calcination by calcining the primary-calcined body at 700° C. to 900° C. for 9 hours to 14 hours (S30).

Next, each step will be described.

First, step (S10) is performed in which a mixture is prepared by mixing a precursor having a nickel content of 80 mol % or more with a lithium raw material.

The D₅₀ of the precursor may range from about 5.5 μm to 9.0 μm, for example, from about 6.0 μm to 8.5 μm. When the D₅₀ of the precursor satisfies the above range, a positive electrode material powder that satisfies the degree of single-particle formation range of the present disclosure and has a D₅₀ of about 4.0 μm or more may be manufactured.

A specific surface area of the precursor measured by BET (Brunauer, Emmett, Teller) may range from about 1 m²/g to 4 m²/g, for example, from about 1.5 m²/g to 3.5 m²/g. Because the degree of single-particle formation of the manufactured positive electrode material powder tends to decrease as the BET value of the precursor increases, when the BET value of the precursor exceeds 4 m²/g, the degree of single-particle formation of the positive electrode material powder may be less than 35%, and when the BET value is less than 1 m²/g, the degree of single-particle formation of the positive electrode material powder may exceed 60%.

Meanwhile, the precursor may be in a form of a hydroxide, an oxide, or a carbonate and may be, for example, in a form of a hydroxide or may have a composition represented by Formula 2:

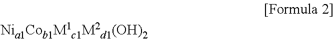

In Formula 2, M¹ is Mn, Al, or a combination thereof, and M² includes one or more elements selected from Zr, W, Ti, Mg, Ba, Ca, Ta, Nb, and Mo, and a1, b1, c1, and d1 satisfy 0.7≤a1<1.0, 0<b1<0.3, 0<c1<0.3, and 0≤d1<0.1.

The symbol “a1” represents a molar ratio of nickel among all metals in the precursor and may satisfy, for example, 0.80≤a1<1.00, 0.81≤a1<1.00, or 0.82≤a1<1.00.

The symbol “b1” represents a molar ratio of cobalt among all metals in the precursor and may satisfy, for example, 0<b1≤0.20, 0<b1≤0.18, or 0<b1≤0.16.

The symbol “c1” represents a molar ratio of the M¹ element among all metals in the precursor and may satisfy, for example, 0<c1≤0.20, 0<c1≤0.18, or 0<c1≤0.16.

The symbol “d1” represents a molar ratio of the M² element among all metals in the precursor and may satisfy, for example, 0≤d1≤0.08, 0≤d1≤0.05, or 0≤d1≤0.03.

The precursor may be either purchased as a commercially available precursor or manufactured according to a precursor manufacturing method known in the art.

Meanwhile, as the lithium raw material, for example, lithium-containing sulfates, nitrates, acetates, carbonates, oxalates, citrates, halides, hydroxides, or oxyhydroxides may be used, and examples of the lithium raw material include Li₂CO₃, LiNO₃, LiNO₂, LiOH, LiOH·H₂O, LiH, LiF, LiCl, LiBr, LiI, CH₃COOLi, Li₂O, Li₂SO₄, CH₃COOLi, Li₃C₆H₅O₇, or mixtures thereof.

The lithium raw material and the precursor may be mixed such that a molar ratio of lithium to total metals in the precursor becomes about 0.8:1.0 to 1.2:1.0, for example, about 0.9:1.0 to 1.1:1.0. When the mixing ratio of metals in the precursor to the lithium raw material satisfies the above range, the layered crystal structure of the lithium nickel-based oxide may be well developed, such that a positive electrode material having excellent capacity characteristics and structural stability may be obtained.

Next, a step of calcining the mixture to produce a calcined body is performed. According to an embodiment, the calcination includes primary calcination and secondary calcination, and the primary calcination may be performed by calcining the mixture under an oxygen atmosphere at about 750° C. to 950° C., for example, at about 800° C. to 900° C. or about 850° C. to 900° C., for about 9 hours to 14 hours. The primary calcination is a step of increasing structural completeness of the lithium-nickel-based oxide and forming single-particle-type particles. Considering the that a higher calcination temperature facilitates particle growth reactions, thereby increasing a degree of single-particle formation, the primary calcination may be performed at about 750° C. or higher according to an embodiment. However, considering the that, when under-calcination occurs during primary calcination, reactivity between the precursor and the lithium raw material decreases, and when the amount of Li₂O increases due to high-temperature calcination, Li₂O is easily converted into LiOH, and LiOH is again easily converted into Li₂CO₃, causing side reactions with an electrolyte and gas generation, the primary calcination may be performed at about 950° C. or lower according to an embodiment. Here, the oxygen atmosphere refers to an atmosphere including a sufficient amount of oxygen for calcination, including an air atmosphere. In general, calcination is performed in an atmosphere in which the oxygen partial pressure is higher than that of air.

The secondary calcination may be performed by calcining the primary-calcined body under an oxygen atmosphere at about 700° C. to 900° C., for example, at about 770° C. to 870° C. or about 780° C. to 820° C. The secondary calcination may be performed for about 9 hours to 14 hours, for example, about 10 hours to 14 hours or about 11 hours to 13 hours. Because the secondary calcination is performed to increase a degree of single-particle formation, the secondary calcination is performed at about 700° C. or higher, and considering that, when the calcination temperature is excessively high, strain and a cation mixing ratio may increase, the secondary calcination is generally performed at about 900° C. or lower.

After the secondary calcination, a step of milling the secondary-calcined body may be performed. Specifically, the method may further include a step of milling the secondary-calcined body at a speed of 1,000 rpm to 2,500 rpm, preferably 1,200 rpm to 2,300 rpm (S40).

According to an embodiment, the milling may be performed at a pressure in a range of about 2.0 bar to 4.0 bar, about 2.2 bar to 3.8 bar, or about 2.4 bar to 3.5 bar. Because particle size tends to decrease as milling pressure increases, when the milling pressure satisfies the above range, a positive electrode material powder satisfying the degree of single-particle formation range of the present disclosure may be manufactured.

The milling process is for removing oversized particles and obtaining the particle size distribution of the positive electrode material powder within a desired range. During the high-temperature calcination process, agglomeration and/or clustering between adjacent particles may occur, resulting in generation of oversized particles, which leads to deterioration in rolling characteristics. Accordingly, in the present disclosure, by performing the milling process, oversized particles may be removed, and a positive electrode material powder having the above-described D₅₀ may be finally formed.

The milling may be performed by a general milling method known in the art, for example, by a jet-mill method, and the above speed refers to a classifier speed.

According to an embodiment, the milling is performed in an atmosphere with low moisture, for example, in a dry air atmosphere. This is because, when a lithium nickel-based oxide is exposed to moisture, generation of lithium by-products increases, and surface physical properties of the active material may deteriorate.

### Positive Electrode

Next, a positive electrode of the present disclosure will be described.

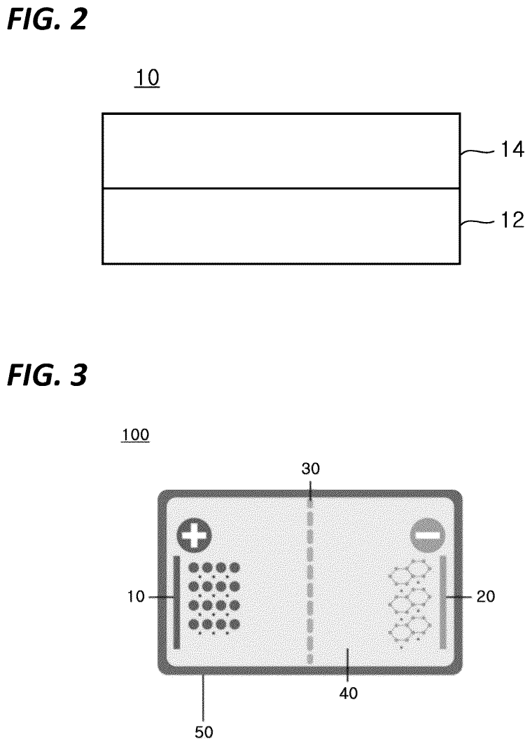

Referring to FIG. 2, according to another embodiment of the present disclosure, a positive electrode 10 including the positive electrode material powder is provided.

The positive electrode according to the present disclosure includes a positive electrode active material layer 14 including the positive electrode material powder described above on a positive electrode current collector 12, and the positive electrode active material layer 14 may further include a positive electrode conductive agent and a positive electrode binder, if necessary. For example, the positive electrode 10 includes a positive electrode current collector 12 and the positive electrode active material layer 14 formed on at least one surface of the positive electrode current collector 12, and the positive electrode active material layer 14 includes a positive electrode active material, a positive electrode conductive agent, and a positive electrode binder. Meanwhile, because the positive electrode material powder is the same as described above, detailed description thereof will be omitted, and the following description will focus on components other than the positive electrode material powder.

In the positive electrode 10, the positive electrode current collector 12 is not particularly limited as long as it has conductivity and does not cause a chemical change in a battery. For example, stainless steel, aluminum, nickel, titanium, calcined carbon, a material produced by surface-treating a surface of aluminum or stainless steel with, for example, carbon, nickel, titanium, or silver may be used. In addition, the positive electrode current collector may typically have a thickness ranging from about 3 μm to 500 μm, and a fine uneven structure may be formed on the surface of the positive electrode current collector to improve the adhesion of the positive electrode active material. For example, the positive electrode current collector may be used in various forms such as a film, a sheet, a foil, a net, a porous body, a foam, and a nonwoven fabric.

According to an embodiment, the positive electrode material powder may be included in an amount ranging from about 90 wt % to 99 wt %, for example, from about 93 wt % to 99 wt %, or about 95 wt % to 98 wt %, based on a total weight of the positive electrode active material layer, that is, a total amount of the positive electrode material powder, the positive electrode conductive agent, and the positive electrode binder. When the content of the positive electrode active material satisfies the above range, a relatively high energy density may be achieved.

The positive electrode conductive agent is used to impart electrical conductivity to the positive electrode 10 and may be used without particular limitation as long as it exhibits electronic conductivity without causing a chemical change in the battery in which it is used. Examples of the positive electrode conductive agent may include: graphite such as natural graphite or artificial graphite; carbon-based materials such as carbon black, acetylene black, Ketjen black, channel black, furnace black, lamp black, thermal black, carbon fiber, or carbon nanotubes; metal powders or metal fibers of, for example, copper, nickel, aluminum, or silver; conductive whiskers of, for example, zinc oxide or potassium titanate; conductive metal oxides such as titanium oxide; or conductive polymers such as polyphenylene derivatives, which may be used either alone or in combination of two or more thereof.

The positive electrode conductive agent may be included in an amount ranging from about 0.1 wt % to 10 wt %, for example, from about 0.5 wt % to 8 wt %, or from about 1 wt % to 5 wt %, based on the total weight of the positive electrode active material layer 14.

The positive electrode binder serves to enhance adhesion between positive electrode active material particles and between the positive electrode active material and the positive electrode current collector. Examples of the positive electrode binder may include: polyvinylidene fluoride (PVDF); vinylidene fluoride-hexafluoropropylene copolymer (PVDF-co-HFP); polyvinyl alcohol; polyacrylonitrile; carboxymethyl cellulose (CMC); starch; hydroxypropyl cellulose; regenerated cellulose; polyvinylpyrrolidone; polytetrafluoroethylene; polyethylene; polypropylene; ethylene-propylene-diene monomer rubber (EPDM rubber); sulfonated EPDM; styrene-butadiene rubber (SBR); fluororubber; or various copolymers thereof, which may be used either alone or in combination of two or more thereof.

The positive electrode binder may be included in an amount ranging from about 0.5 wt % to 5 wt %, for example, from about 1 wt % to 4 wt %, or from about 1 wt % to wt %, based on the total weight of the positive electrode active material layer 14.

The positive electrode 10 may be manufactured according to a conventional positive electrode manufacturing method. For example, the positive electrode 10 may be manufactured by preparing a positive electrode slurry by mixing a positive electrode powder, a positive electrode binder, and/or a positive electrode conductive agent in a solvent, coating the positive electrode slurry onto a positive electrode current collector 12, and drying and rolling the coated layer. Alternatively, the positive electrode 10 may be manufactured by casting the positive electrode slurry onto a separate support, peeling off the resulting film from the support, and laminating the film obtained thereby onto the positive electrode current collector 12.

Meanwhile, solvents generally used in the art may be used as the solvent for the positive electrode slurry, and, for example, dimethyl sulfoxide (DMSO), isopropyl alcohol, N-methyl-2-pyrrolidone (NMP), acetone, and water, may be used alone or in combination of two or more. The amount of solvent used may only need to be sufficient to dissolve or disperse the positive electrode active material, the conductive agent, and the binder considering a coating thickness of the slurry and manufacturing yield, and to provide a viscosity capable of exhibiting excellent coating thickness uniformity during coating for subsequent positive electrode fabrication.

### Lithium Secondary Battery

Next, a lithium secondary battery according to the present disclosure will be described.

Referring to FIG. 3, according to another embodiment of the present disclosure, a lithium secondary battery 100 including the above-mentioned positive electrode is provided.

The lithium secondary battery 100 according to an embodiment of the present disclosure includes: a positive electrode 10 according to the present disclosure; a negative electrode 20 disposed to face the positive electrode 10; a separator 30 interposed between the positive electrode 10 and the negative electrode 20; and an electrolyte 40. In addition, the lithium secondary battery 100 according to an embodiment of the present disclosure includes an electrode assembly formed of the positive electrode 10, the negative electrode 20, and the separator 30, and a battery case 50 that accommodates the electrode assembly and the electrolyte 40.

The lithium secondary battery 100 according to an embodiment of the present disclosure has excellent lifetime characteristics due to low gas generation while also exhibiting excellent capacity characteristics and high-temperature stability. The lithium secondary battery 100, which exhibits stable high-temperature performance, may be used not only as a battery cell for small devices such as mobile phones, notebook computers, and digital cameras, but also preferably as a unit cell of a battery module for medium- and large-sized devices including a plurality of battery cells. Examples of the medium- and large-sized devices include power tools, electric vehicles, hybrid electric vehicles, plug-in hybrid electric vehicles, and power storage systems, but are not limited thereto.

In the lithium secondary battery, the negative electrode 20 includes a negative electrode active material, a negative electrode conductive agent, and a negative electrode binder. For example, the negative electrode 20 includes a negative electrode current collector and a negative electrode active material layer formed on at least one surface of the negative electrode current collector, and the negative electrode active material layer includes a negative electrode active material, a negative electrode conductive agent, and a negative electrode binder.

The negative electrode current collector is not particularly limited as long as it has high conductivity and does not cause a chemical change in the battery. For example, copper, stainless steel, aluminum, nickel, titanium, calcined carbon, a material produced by surface-treating the surface of copper or stainless steel with, for example, carbon, nickel, titanium, or silver, or an aluminum-cadmium alloy may be used. In addition, the negative electrode current collector may typically have a thickness ranging from about 3 m to 500 μm. Similarly to the positive electrode current collector, a fine uneven pattern may be formed on the surface of the current collector to enhance the adhesion strength of the negative electrode active material. For example, the negative electrode current collector may be used in various forms such as a film, a sheet, a foil, a net, a porous body, a foam, and a nonwoven fabric.

As the negative electrode active material, a compound capable of reversibly intercalating and deintercalating the lithium ions may be used. Examples of the negative electrode active material may include: carbon-based materials such as artificial graphite, natural graphite, graphitized carbon fiber, and amorphous carbon; metallic compounds capable of alloying with lithium, such as Si, Al, Sn, Pb, Zn, Bi, In, Mg, Ga, Cd, Si alloys, Sn alloys, or Al alloys; metal oxides capable of intercalating and deintercalating the lithium ions, such as SiO_{β} (0<β<2), SnO₂, vanadium oxides, and lithium vanadium oxides; or composites including the above-described metallic compounds and carbon-based materials, such as Si—C composites or Sn—C composites, which may be used either alone or in combination of two or more thereof.

The negative electrode active material layer may be included in an amount ranging from about 80 wt % to 98 wt %, for example, from about 90 wt % to 98 wt %, or from about 93 wt % to 98 wt %, based on the total weight of the negative electrode active material layer. When the content of the negative electrode active material satisfies the above range, excellent energy density may be achieved.

The negative electrode conductive agent is used to impart electrical conductivity to the negative electrode 20 and may be used without particular limitation as long as it exhibits electronic conductivity without causing a chemical change in the battery 100 in which it is used. Examples of the negative electrode conductive agent may include: graphite such as natural graphite or artificial graphite; carbon-based materials such as carbon black, Super C, acetylene black, Ketjen black, channel black, furnace black, lamp black, thermal black, carbon fiber, or carbon nanotubes; metal powders or metal fibers of, for example, copper, nickel, aluminum, or silver; conductive whiskers of, for example, zinc oxide or potassium titanate; conductive metal oxides such as titanium oxide; or conductive polymers such as polyphenylene derivatives, which may be used either alone or in combination of two or more thereof.

The negative electrode conductive agent may be typically included in an amount ranging from about 0.1 wt % to 10 wt %, for example, from about 0.5 wt % to 8 wt %, or from about 0.8 wt % to 5 wt %, based on the total weight of the negative electrode active material.

The negative electrode binder serves to enhance adhesion between negative electrode active material particles and between the negative electrode active material and the negative electrode current collector. Examples of the positive electrode binder may include: polyvinylidene fluoride (PVDF); vinylidene fluoride-hexafluoropropylene copolymer (PVDF-co-HFP); polyvinyl alcohol; polyacrylonitrile; carboxymethyl cellulose (CMC); starch; hydroxypropyl cellulose; regenerated cellulose; polyvinylpyrrolidone; polytetrafluoroethylene; polyethylene; polypropylene; ethylene-propylene-diene monomer rubber (EPDM rubber); sulfonated EPDM; styrene-butadiene rubber (SBR); fluororubber; or various copolymers thereof, which may be used either alone or in combination of two or more thereof.

The negative electrode binder may be included in an amount ranging from about 1 wt % to 10 wt %, for example, from about 1 wt % to 8 wt %, or from about 1 wt % to 5 wt %, based on the total weight of the negative electrode active material layer.

In the lithium secondary battery 100, the electrolyte 40 may include an organic solvent and a lithium salt.

The organic solvent may be used without particular limitation as long as it serves as a medium that allows ions involved in the electrochemical reactions of the battery to move therethrough. Examples of the organic solvent may include: ester-based solvents such as methyl acetate, ethyl acetate, γ-butyrolactone, and ε-caprolactone; ether-based solvents such as dibutyl ether and tetrahydrofuran; ketone-based solvents such as cyclohexanone; aromatic hydrocarbon-based solvents such as benzene and fluorobenzene; carbonate-based solvents such as dimethyl carbonate (DMC), diethyl carbonate (DEC), methylethylcarbonate (MEC), ethyl methyl carbonate (EMC), ethylene carbonate (EC), and propylene carbonate (PC); alcohol-based solvents such as ethyl alcohol and isopropyl alcohol; nitriles such as R—CN (where R is a straight-chain, branched, or cyclic hydrocarbon group of C2 to C20 and may include a double bond or an ether bond); amides such as dimethylformamide; dioxolanes such as 1,3-dioxolane; or sulfolanes. Among these, a carbonate-based solvent may be used, and for example, a mixture of a cyclic carbonate compound having high ionic conductivity and high dielectric constant (e.g., ethylene carbonate or propylene carbonate) to enhance charge/discharge performance, and a low-viscosity linear carbonate compound (e.g., ethyl methyl carbonate, dimethyl carbonate, or diethyl carbonate) may be used.

The lithium salt may be used without particular limitation as long as it is a compound capable of providing lithium ions used in a lithium secondary battery. Specifically, as the lithium salt, for example, LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCi, LiI, or LiB(C₂O₄)₂ may be used. According to an embodiment, the concentration of the lithium salt is preferably in a range of about 0.1 M to 3.0 M, for example, about 0.1 M to 2.0 M or about 0.5 M to 1.5 M. When the concentration of the lithium salt is included within the above-mentioned range, the electrolyte has appropriate conductivity and viscosity, so that excellent electrolyte performance may be achieved and lithium ions may effectively move.

The electrolyte may further include, in addition to the above-described electrolyte components, an additive for purposes such as improving lifetime characteristics of the battery, suppressing capacity degradation of the battery, or enhancing discharge capacity of the battery. For example, as the additive, various additives used in the art, such as fluoroethylene carbonate (FEC), vinylene carbonate (VC), vinyl ethylene carbonate (VEC), ethylene sulfate (ESa), lithium difluorophosphate (LiPO₂F₂), lithium bis(oxalato)borate (LiBOB), lithium tetrafluoroborate (LiBF₄), lithium difluoro(oxalato)borate (LiDFOB), lithium difluoro(bisoxalato)phosphate (LiDFBP), lithium tetrafluoro(oxalato)phosphate (LiTFOP), lithium methyl sulfate (LiMS), lithium ethyl sulfate (LiES), propanesultone (PS), propene sultone (PRS), succinonitrile (SN), adiponitrile (AND), 1,3,6-hexanetricarbonitrile (HTCN), 1,4-dicyano-2-butene (DCB), fluorobenzene (FB), ethyl di(propan-2-yl) phosphate (EDP), and 5-methyl-5-propargyloxycarbonyl-1,3-dioxane-2-one (MPOD), may be used alone or in combination, but are not limited thereto. According to an embodiment, the additive may be included in an amount ranging from about 0.1 wt % to 10 wt %, for example, from about 0.1 wt % to 5 wt %, based on the total weight of the electrolyte.

The lithium secondary battery 100 may further include, as needed, a separator 30 between the positive electrode and the negative electrode. The separator 30 separates the negative electrode and the positive electrode and provides a path for lithium-ion migration. Any separator commonly used in lithium secondary batteries may be used without particular limitation, and a separator that exhibits low resistance to ion movement of the electrolyte and excellent electrolyte wettability is generally used. For example, a porous polymer film made of a polyolefin-based polymer such as an ethylene homopolymer, a propylene homopolymer, an ethylene/butene copolymer, an ethylene/hexene copolymer, or an ethylene/methacrylate copolymer, or a laminated structure including two or more layers thereof, may be used. In addition, a conventional porous nonwoven fabric such as a nonwoven fabric made of, for example, high melting point glass fiber or polyethylene terephthalate fiber may be used. In addition, a coated separator 30 containing a ceramic component or a polymer material to secure heat resistance or mechanical strength may be used, and may optionally be used in a single-layer or multi-layer structure.

The lithium secondary battery 100 may further include, as needed, a battery case 50 accommodating an electrode assembly including the positive electrode, the negative electrode, and the separator 30. The battery case 50 according to an embodiment of the present disclosure may be manufactured in various shapes, for example, in prismatic, pouch, coin, or cylindrical types.

Hereinafter, embodiments of the present disclosure will be described in detail so that those skilled in the art to which the present disclosure pertains can readily practice the present disclosure. However, the present disclosure may be implemented in many different forms, and is not limited to the embodiments described herein.

### Manufacturing Example: Preparation of Positive Electrode Material Powder

### Example 1

Nickel-cobalt-manganese hydroxide powder serving as a precursor, which had a molar ratio of Ni:Co:Mn of 83:11:6, a D₅₀ of 7.5 μm, which is a volume cumulative average as measured using a particle size analyzer, and a specific surface area of 2.5 m²/g as measured by the BET method, was mixed with lithium hydroxide such that a molar ratio of Li:transition metal (Ni+Co+Mn) became 1.05:1.00. Thereafter, the mixture was primarily calcined at 870° C. for 12 hours and then secondarily calcined at 800° C. for 12 hours. Subsequently, the calcined material was pulverized in a jet mill at a gas pressure of 3 bar and a rotation speed of 2,000 rpm to prepare a positive electrode material powder.

### Example 2

A positive electrode material powder was prepared in the same manner as in Example 1, except that nickel-cobalt-manganese hydroxide powder having a D₅₀ of 9.0 μm and a specific surface area of 2.5 m²/g was used as the precursor.

### Comparative Example 1

A positive electrode material powder was prepared in the same manner as in Example 1, except that nickel-cobalt-manganese hydroxide powder having a specific surface area of 5.0 m²/g was used as the precursor.

### Comparative Example 2

A positive electrode material powder was prepared in the same manner as in Example 1, except that nickel-cobalt-manganese hydroxide powder having a D₅₀ of 9.0 μm and a specific surface area of 2.5 m²/g was used as the precursor, and primary calcination was performed at 900° C. for 15 hours.

### Comparative Example 3

A positive electrode material powder was prepared in the same manner as in Example 1, except that nickel-cobalt-manganese hydroxide powder having a D₅₀ of 5.0 μm and a specific surface area of 6.0 m²/g was used as the precursor.

### Experimental Example 1. Measurement of Degree of Single-Particle Formation

### 1-1. Measurement of D₅₀

Each 0.1 g of the positive electrode material powders prepared in Examples 1 and 2 and Comparative Examples 1 to 3 was dispersed in a dispersion medium, and then the dispersed sample was introduced into a laser diffraction particle size analyzer (Microtrac MT 3000) and irradiated with ultrasonic waves of about 28 kHz at an output of 60 W to measure the D₅₀ of each positive electrode material powder. The measurement results are shown in Table 1 below.

### 1-2. Measurement of Primary Particle Area

In addition, using a scanning electron microscope (SEM), SEM images of each of the positive electrode material powders prepared in Examples 1 and 2 and Comparative Examples 1 to 3 were obtained. Areas of primary particles identifiable in the measured SEM images were measured, and a median value A of the measured values was derived. A value of 2(A/π)^{1/2} was then calculated and is shown in Table 1 below.

### 1-3. Calculation of Degree of Single-Particle Formation

The above-calculated D₅₀ and 2(A/π)^{1/2} values were substituted into Equation 1 to calculate the degree of single-particle formation, and the results are shown in Table 1 below.

TABLE 1

| | Example | Example | Comparative | Comparative | Comparative |
|---|---|---|---|---|---|
| | 1 | 2 | Example 1 | Example 2 | Example 3 |
| 2(A/π)^{1/2}[μm] | 2.36 | 3.27 | 2.02 | 4.01 | 1.59 |
| D₅₀[μm] | 5.905 | 6.53 | 6.045 | 6.54 | 3.82 |
| Degree of single- | 40 | 50 | 33 | 61 | 42 |
| particle formation | | | | | |

Referring to Table 1, the D₅₀ values of the positive electrode material powders of Examples 1 and 2 and Comparative Examples 1 and 2 were found to be 4 μm or more, whereas in the case of Comparative Example 3, the D₅₀ was found to be less than 4 μm. In addition, the degrees of single-particle formation of Examples 1 and 2 were 40% and 50%, respectively, which fall within the range of about 35% to 60%, whereas in Comparative Examples 1 and 2, the degrees of single-particle formation were 33% and 61%, respectively, which are outside the range of about 35% to 60%. However, in the case of Comparative Example 3, the degree of single-particle formation was 42%, which falls within the range of about 35% to 60%.

### Experimental Example 2. Evaluation of Powder Properties

### 2-1. Measurement of Tap Density

The tap densities of the positive electrode material powders prepared in Examples 1 and 2 and Comparative Examples 1 to 3 were measured using a tap density measuring device (GEOPYC 1360 from Micromeritics). For example, 10 g of each positive electrode material powder prepared in Examples 1 and 2 and Comparative Examples 1 to 3 was filled into a container having a diameter of 19 mm, and the tap density was measured by vibrating the container until a horizontal force of 108 N was applied. The results are shown in Table 2 below.

### 2-2. Measurement of Rolling Density

The rolling densities of the positive electrode material powders prepared in Examples 1 and 2 and Comparative Examples 1 to 3 were measured using a density measuring device (Caver Pellet Press). Specifically, 3 g of each positive electrode material powder prepared in Examples 1 and 2 and Comparative Examples 1 to 3 was dispensed and packed without voids into a cylindrical holder having a diameter of 13 mm, and a pressure of 9 tons was applied to measure each rolling density.

TABLE 2

| | Example | Example | Comparative | Comparative | Comparative |
|---|---|---|---|---|---|
| | 1 | 2 | Example 1 | Example 2 | Example 3 |
| Tap density [g/cc] | 1.92 | 2.27 | 1.63 | 2.38 | 1.74 |
| Rolling density | 3.63 | 3.66 | 3.54 | 3.67 | 3.42 |
| [g/cc] | | | | | |

From the results of Table 2, it can be seen that Comparative Example 1, in which the degree of single-particle formation is less than 35%, exhibits a relatively low tap density, and that Comparative Example 3, in which the D₅₀ of the positive electrode material powder is less than 4 μm, exhibits inferior tap density and rolling density even when the degree of single-particle formation satisfies the above-described range.

### Experimental Example 3. Evaluation of Battery Performance

### 3-1. Manufacture of Mono-Cell

Positive electrode slurries were prepared by mixing each of the positive electrode material powders prepared in Examples 1 and 2 and Comparative Examples 1 to 3, carbon black as a conductive agent, and PVDF as a binder in a weight ratio of 96.5:1.5:2.0 in an NMP solvent. The prepared positive electrode slurry was applied onto one surface of an aluminum current collector and then dried at 130° C. and rolled to manufacture a positive electrode.

In addition, a negative electrode slurry was prepared by mixing graphite as a negative electrode active material, Super C as a conductive agent, and SBR/CMC as a binder in a weight ratio of 95.6:1.0:3.4. The negative electrode slurry was applied onto one surface of a copper current collector, dried at 130° C., and rolled to manufacture a negative electrode.

An electrode assembly was manufactured by interposing a separator between the positive electrode and the negative electrode. The electrode assembly was then placed inside a battery case, and an electrolyte was injected into the case to manufacture a lithium secondary battery mono-cell. The electrolyte was prepared by dissolving LiPF₆ at a concentration of 1 M in a mixed organic solvent obtained by mixing ethylene carbonate/dimethyl carbonate/diethyl carbonate at a volume ratio of 1:2:1, and adding 2 wt % of vinylene carbonate (VC).

### 3-2. Evaluation of Gas Generation Amount

After performing a formation process on each of the manufactured cells, the cells were charged at 25° C. at a constant current (CC) of 0.1 C (reference capacity: 1 C=40 mAh/g) until reaching 4.25 V, and were then charged in a constant voltage (CV) mode until the charging current reached 0.05 C (cut-off current). Thereafter, while storing the cells in a chamber at 60° C., each cell was taken out of the chamber at one-week intervals, and the change in volume was calculated by applying the Archimedes' principle using a hydrometer (MATSUHAKU, TWD-150DM). Based on the results measured over eight weeks, the average weekly volume change was calculated and is shown in Table 3 below.

TABLE 3

| | Example | Example | Comparative | Comparative | Comparative |
|---|---|---|---|---|---|
| | 1 | 2 | Example 1 | Example 2 | Example 3 |
| Gas generation | 0.175 | 0.194 | 0.255 | 0.27 | 0.335 |
| amount [ml] | | | | | |

From the results of Table 3, it can be seen that the cells of Examples 1 and 2 exhibit relatively lower gas generation compared to the Comparative Examples, and in particular, Comparative Example 3, in which the D₅₀ of the positive electrode material powder is less than 4 μm, exhibits significantly higher gas generation.

### 3-3. Evaluation of High-Temperature Stability

To evaluate high-temperature stability, the heat flow according to temperature of the positive electrodes prepared in Examples 1 and 2 and Comparative Examples 1 to 3 was measured using a differential scanning calorimeter (DSC) (manufactured by Setaram, model name: SENSYS evo DSC).

For example, each of the cells of Examples 1 and 2 and Comparative Examples 1 to 3 was charged at 25° C. at a constant current of 0.1 C until reaching 4.25 V, after which the cells were disassembled, and the positive electrodes were separated. The separated positive electrodes were washed with dimethyl carbonate and then immersed in L of an electrolyte (1 M LiPF₆, EC:DMC:EMC=3:4:3 by volume), and a DSC analysis was performed on the positive electrode active material. The temperature range for the DSC analysis was set to 25° C. to 400° C., and the heating rate was set to 10° C./min. For each positive electrode, DSC measurements were carried out three or more times to calculate an average value. The measurement results are shown in Table 4 below. Meanwhile, DSC analysis is an abbreviation for Differential Scanning Calorimetry, which is a thermal analysis technique that measures the difference in heat flow generated when a sample is heated or cooled and analyzes the thermal properties of a material (e.g., melting point, glass transition temperature, and phase transitions). Through this analysis, various types of information regarding the physical and chemical reactions and thermal stability of a material may be obtained.

TABLE 4

| | Example | Example | Comparative | Comparative | Comparative |
|---|---|---|---|---|---|
| | 1 | 2 | Example 1 | Example 2 | Example 3 |
| Intensity of main | 11 | 13.4 | 11.2 | 19.9 | 10.6 |
| DSC peak | | | | | |

Referring to Table 4, it can be seen that the positive electrode of Comparative Example 2, in which the degree of single-particle formation exceeds 60%, exhibits a higher intensity of the main DSC peak and therefore has lower high-temperature stability compared to Examples 1 and 2, Comparative Example 1, and Comparative Example 3.

In addition, from the results of Tables 3 and 4, it can be seen that the cells to which the positive electrode material powders of Examples 1 and 2, which have a D₅₀ of 4 μm or more and satisfy the degree of single-particle formation of Equation 1, are applied exhibit low gas generation and excellent high-temperature stability.

As described above, the positive electrode material powder according to an embodiment of the present disclosure reduces gas generation occurring in a battery while improving thermal stability by controlling the single-crystallization of high-Ni single crystals. To this end, according to an embodiment of the present disclosure, the Doo value of a precursor excluding lithium is controlled to be about 5.5 μm to 9.0 μm, the specific surface area value of the precursor is controlled within a range of 1 m²/g to 4 m²/g, and, under the above conditions, the D₅₀ value of a positive electrode material powder manufactured through primary and secondary calcination and a milling process is controlled to be 4 μm or more and the degree of single-particle formation is controlled to be about 35% to 60%. A lithium secondary battery manufactured using the positive electrode material powder prepared in this manner can be confirmed to exhibit low gas generation and excellent high-temperature stability.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A positive electrode material powder comprising:
a lithium nickel-based oxide having a nickel content of 80 mol % or more among metals excluding lithium,
wherein the positive electrode material powder has an average particle size (D₅₀) of 4 μm or more, and
the positive electrode material powder has a degree of single-particle formation, represented by Equation 1 below, of about 35% to 60%.
$$Degree of single - particle formation ( \% ) = \frac{\sqrt[2]{A / π}}{{D}_{s o}} \times 100 \qquad [ Equation 1 ]$$
wherein, A (unit: μm²) is a median of primary particle areas of the positive electrode material powder measured through SEM image analysis, and D₅₀ (unit: μm) is a volumetric cumulative average of the positive electrode material powder measured using a particle size analyzer.

2. The positive electrode material powder according to claim 1, wherein the positive electrode material powder includes a single particle formed from one primary particle or a quasi-single-particle that is an aggregate of 50 or fewer primary particles.

3. The positive electrode material powder according to claim 1, wherein the lithium nickel-based oxide has a composition represented by Formula 1: 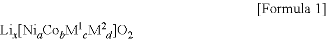
wherein, M¹ is Mn, Al, or a combination thereof, M² includes one or more elements selected from Zr, W, Ti, Mg, Ba, Ca, Ta, Nb, and Mo, and x, a, b, c, and d satisfy 0.8≤x≤1.2, 0.7≤a<1.0, 0<b<0.3, 0<c≤0.3, and 0≤d≤0.1.

4. The positive electrode material powder according to claim 1, wherein
$$\sqrt[2]{A / π}$$
in Equation 1 is about 1 μm to 4 μm.

5. The positive electrode material powder according to claim 1, wherein the positive electrode material powder has a tap density of about 1.80 g/cc or more.

6. The positive electrode material powder according to claim 1, wherein the positive electrode material powder has a rolling density of about 3.50 g/cc or more, as measured after being pressed at 9 tons.

7. The positive electrode material powder according to claim 1, further comprising:
a coating layer including one or more coating elements selected from Al, Ti, W, B, F, P, Mg, Ni, Co, Fe, Cr, V, Cu, Ca, Zn, Zr, Nb, Mo, Sr, Sb, Bi, Si, and S on a surface of the lithium nickel-based oxide.

8. The positive electrode material powder according to claim 1, wherein the positive electrode material powder has an average particle size (D₅₀) of about 4 μm to 7 μm.

9. A positive electrode for a lithium secondary battery, comprising the positive electrode material powder according to claim 1.

10. A lithium secondary battery comprising the positive electrode according to claim 9.
